(19) United States
(12) Patent Application Publication
(10) Pub. No.: US 2011/0292462 A1
(43) Pub. Date: Dec. 1, 2011

(54) IMAGE PROCESSING APPARATUS, IMAGE PROCESSING METHOD, AND COMPUTER-READABLE STORAGE MEDIUM FOR COMPUTER PROGRAM

(75) Inventor: Tomoo YAMANAKA, Toyokawa-shi (JP)

(73) Assignee: Konica Minolta Business Technologies, Inc., Tokyo (JP)

(21) Appl. No.: 13/149,412

(22) Filed: May 31, 2011

(30) Foreign Application Priority Data
Jun. 1, 2010 (JP) 2010-125709

(51) Int. Cl. G06K 9/36

(52) U.S. Cl. 358/448

(57) ABSTRACT

An image processing apparatus is provided for performing image processing on an image containing a first image and a second image representing a translucent object. The image processing apparatus includes a detector that detects a non-overlapping region in the second image, the non-overlapping region being a region that does not overlap the first image, and an equalizing portion that makes gradations in the non-overlapping region uniform.

This application is based on Japanese patent application No. 2010-125709 filed on Jun. 1, 2010, the contents of which are hereby incorporated by reference.

### BACKGROUND OF THE INVENTION

1. Field of the Invention

The present invention relates to an apparatus, method, and computer-readable storage medium for computer program for performing image processing on a translucent image.

2. Description of the Related Art

Image forming apparatuses having a variety of functions, such as copying, PC printing, scanning, faxing, and file server, have recently come into widespread use. Such image forming apparatuses are sometimes called “multifunction devices”, “Multi-Function Peripherals (MFPs)”, or the like.

The PC printing function is to receive image data from a personal computer and to print an image onto paper based on the image data.

In recent years, applications used for drawing in a personal computer have been available in the market. Such applications are called “drawing software”. Some pieces of drawing software are equipped with a function to show a translucent image on a display.

The “translucent image” herein has properties which allow another object image placed in the rear thereof to be visible through the translucent image itself. Referring to FIG. 4A, for example, a translucent image 50a is placed in the foreground, or, in other words, placed above or on a rear image 50b. However, a part of the rear image 50b overlapping the translucent image 50a is visible through the translucent image 50a. Higher transmissivity of the translucent image 50a allows the rear image 50b to be more visible therethrough. In short, the translucent image is an image representing a translucent object.

An image forming apparatus is capable of printing, onto paper, a translucent image displayed on a personal computer. Before the translucent image is printed out, the translucent image undergoes a pixel decimation process depending on the level of the transmissivity thereof (see FIGS. 5B and 5C). Then, another image, placed in the back of the translucent image, is printed at positions of pixels of the translucent image that have been decimated therefrom. In this way, the other image is visible through the translucent image.

There has been proposed a method for minimizing change of color tone in an image containing a translucent image after screen processing. For example, translucent image data is generated by overlaying a translucent object on PDL data to be rendered translucent. Screen processing is then performed on the translucent image data by dither processing. Subsequently, it is determined whether to define the screen processed translucent image data as the image data for printing. If it is determined that the screen processed translucent image data is not defined as the image data for printing, a halftone value of the translucent object is modified to be larger than the current value.

As discussed above, pixels of a translucent image to be printed are decimated and form a grid-like pattern. Accordingly, the translucent image printed on paper seems to have high graininess as compared to the translucent image on a display.

### SUMMARY

The present disclosure is directed to solve the problems pointed out above, and therefore, an object of an embodiment of the present invention is to reduce graininess in a translucent image as compared to conventional techniques.

An image processing apparatus according to an aspect of the present invention is an image processing apparatus for performing image processing on an image containing a first image and a second image representing a translucent object. The image processing apparatus includes a detector that detects a non-overlapping region in the second image, the non-overlapping region being a region that does not overlap the first image, and an equalizing portion that makes gradations in the non-overlapping region uniform.

Preferably, if the second image includes one or more pixel groups each of which has one or more continuous pixels and has density greater than density of neighboring pixels adjacent to each of the one or more pixel groups, then the detector detects the non-overlapping region by selecting, from among the one or more pixel groups, a pixel group that is not adjacent to the neighboring pixels having density equal to or greater than a predetermined value, and performing closing processing on a distribution image representing distribution of the pixel group thus selected. In such a case, the equalizing portion makes the gradations in the non-overlapping region uniform based on a size of the non-overlapping region, density, a size, and a quantity of the pixel group selected.

Preferably, if the second image includes one or more pixel groups each of which has one or more continuous pixels and has density less than density of neighboring pixels adjacent to each of the one or more pixel groups, then the detector detects the non-overlapping region by selecting, from among the one or more pixel groups, a pixel group having density less than a predetermined value, and performing closing processing on a distribution image representing distribution of the pixel group thus selected. In such a case, the equalizing portion makes the gradations in the non-overlapping region uniform based on a size of the non-overlapping region, density of the neighboring pixels, a size and a quantity of the pixel group selected.

These and other characteristics and objects of the present invention will become more apparent by the following descriptions of preferred embodiments with reference to drawings.

### BRIEF DESCRIPTION OF THE DRAWINGS

FIG. 1 is a diagram illustrating an example of a network system including an image forming apparatus.

FIG. 2 is a diagram illustrating an example of the hardware configuration of an image forming apparatus.

FIG. 3 is a diagram illustrating an example of the configuration of an image processing circuit.

FIGS. 4A and 4B are diagrams illustrating examples of the positional relationship between a translucent image and a rear image both of which are contained in a document image.

FIGS. 5A to 5C are diagrams illustrating examples of a translucent image.

FIG. 6 is a diagram illustrating an example as to how a translucent image and a rear image overlap with each other in pixels.

FIGS. 7A and 7B are diagrams illustrating examples of isolated points each of which consists of a plurality of pixels.

FIG. 8 is a diagram illustrating an example of the configuration of a translucent image adjustment portion.

FIG. 9 is a diagram illustrating an example of the configuration of a non-overlapping region detection portion.

FIGS. 10A and 10B are diagrams illustrating examples as to how a translucent image and a rear image overlap with each other in pixels for the case of high transmissivity and for the case of low transmissivity, respectively.

FIG. 11 is a diagram illustrating an example of a translucent image having transmissivity of 50%.

### DESCRIPTION OF THE PREFERRED EMBODIMENTS

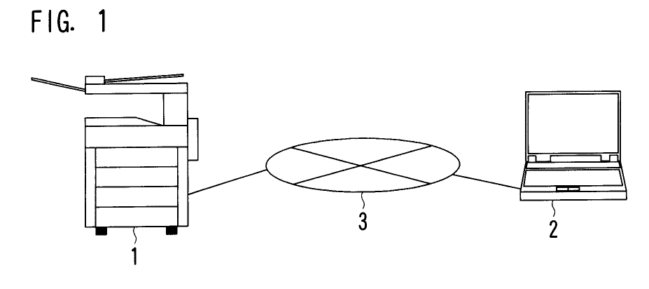

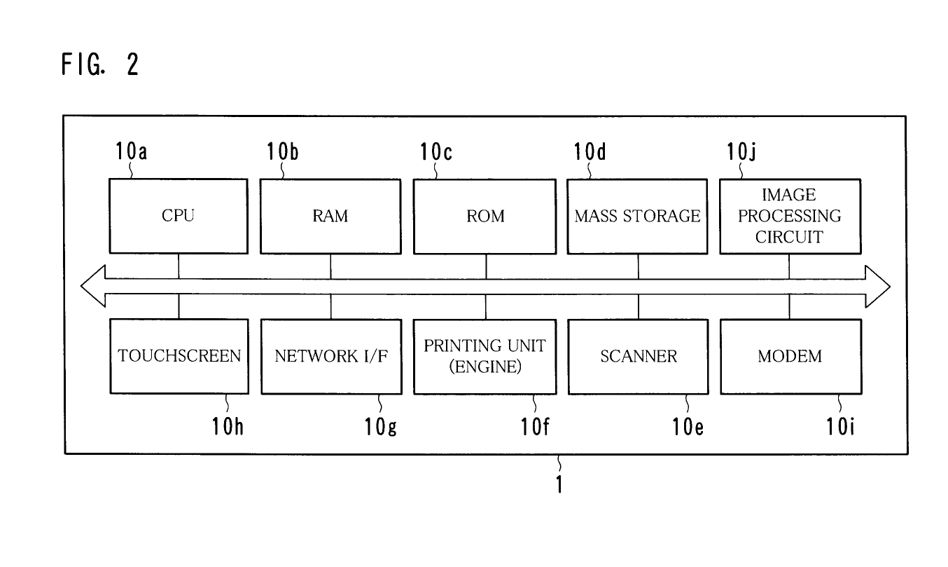

FIG. 1 is a diagram illustrating an example of a network system including an image forming apparatus 1, and FIG. 2 is a diagram illustrating an example of the hardware configuration of the image forming apparatus 1.

The image forming apparatus 1 shown in FIG. 1 is an apparatus generally called a multifunction device, a Multi-Function Peripheral (MFP), or the like. The image forming apparatus 1 is configured to integrate, thereinto, a variety of functions, such as copying, network printing (PC printing), faxing, and scanning.

The image forming apparatus 1 is capable of sending and receiving image data with a device such as a personal computer 2 via a communication line 3, e.g., a Local Area Network (LAN), a public line, or the Internet.

Referring to FIG. 2, the image forming apparatus 1 is configured of a Central Processing Unit (CPU) 10a, a Random Access Memory (RAM) 10b, a Read-Only Memory (ROM) 10c, a mass storage 10d, a scanner 10e, a printing unit 10f, a network interface 10g, a touchscreen 10h, a modem 10i, an image processing circuit 10j, and so on.

The scanner 10e is a device that reads images printed on paper, such as photographs, characters, drawings, diagrams, and the like, and creates image data thereof.

The touchscreen 10h displays, for example, a screen for giving a message or instructions to a user, a screen for the user to enter a process command and process conditions, and a screen for displaying the result of a process performed by the CPU 10a. The touchscreen 10h also detects a position thereof touched by the user with his/her finger, and sends a signal indicating the result of the detection to the CPU 10a.

The network interface 10g is a Network Interface Card (NIC) for communicating with another device such as the personal computer 2 via the communication line 3.

The modem 10i is a device for transmitting image data via a fixed-line telephone network to another facsimile terminal and vice versa based on a protocol such as Group 3 (G3).

The image processing circuit 10j serves to perform image processing, based on image data transmitted from the personal computer 2, on object images contained in an image to be printed. The individual portions of the image processing circuit 10j are implemented by a circuit such as an Application Specific Integrated Circuit (ASIC) or a Field Programmable Gate Array (FPGA). The processes performed by the individual portions of the image processing circuit 10j are described later.

The printing unit 10f serves to print, onto paper, an image obtained by scanning with the scanner 10e or an image that has undergone the image processing by the image processing circuit 10j.

The ROM 10c and the mass storage 10d store, therein, Operating System (OS) and programs such as firmware and application. These programs are loaded into the RAM 10b as necessary, and executed by the CPU 10a. An example of the mass storage 10d is a hard disk or a flash memory.

Detailed descriptions are given below of the configuration of the image processing circuit 10j and image processing by the image processing circuit 10j.

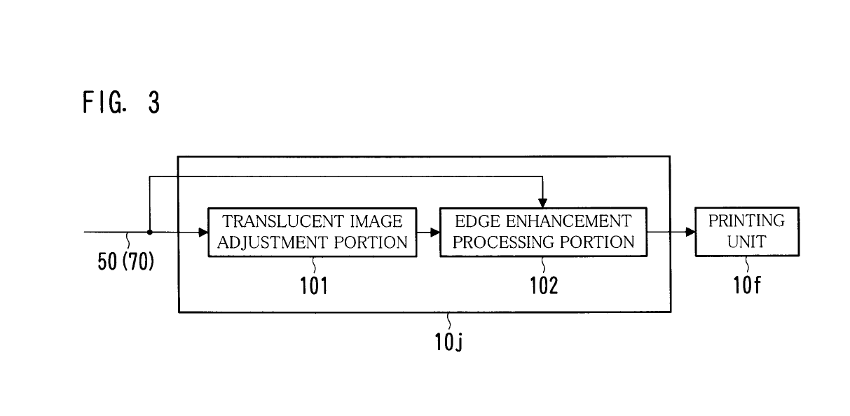

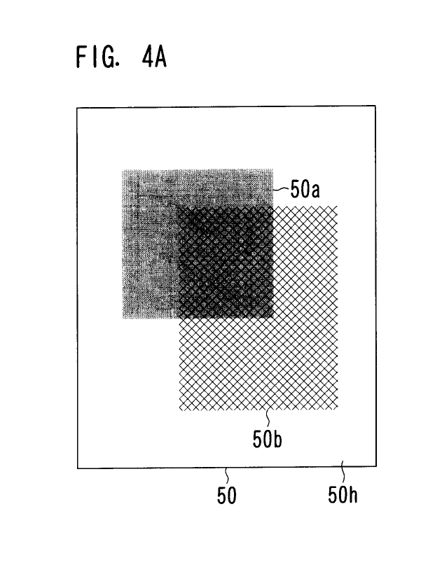

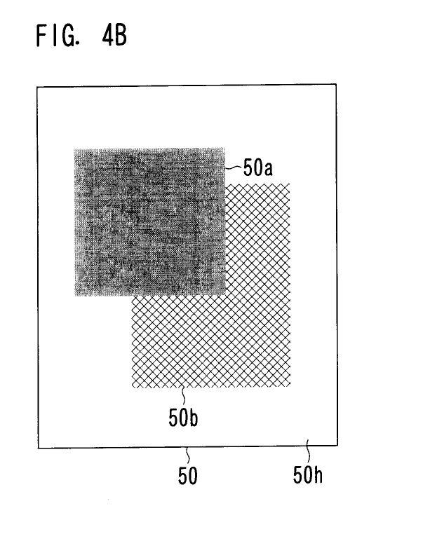

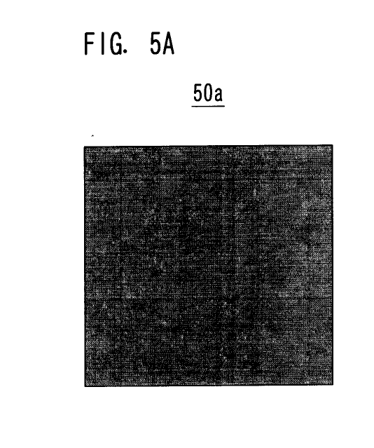

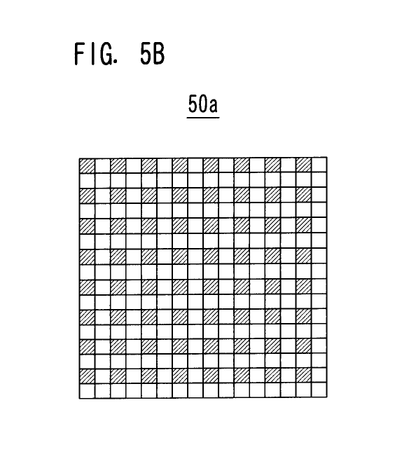

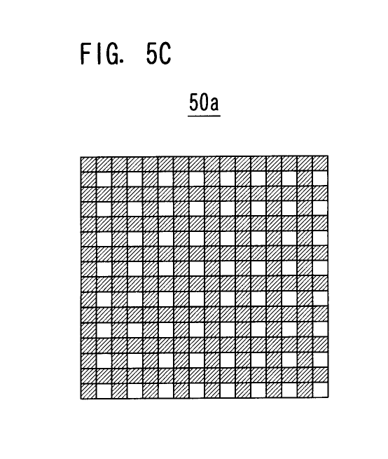

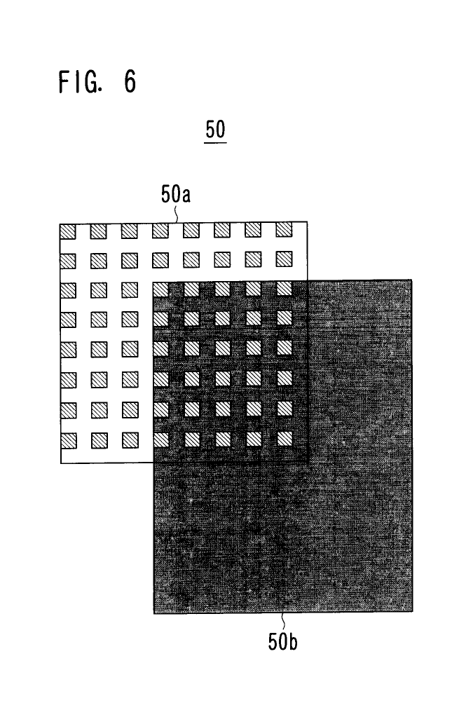

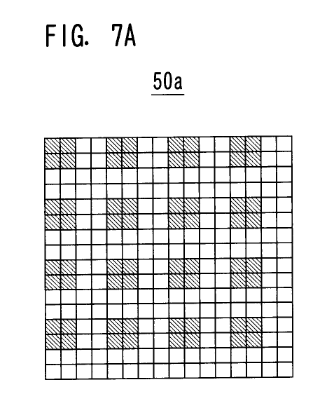

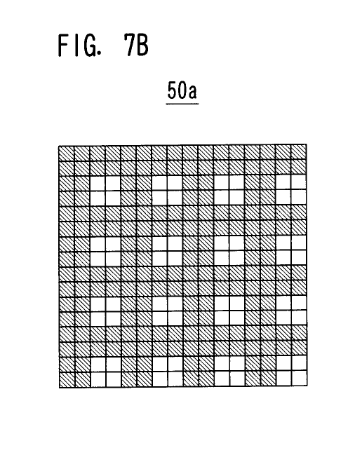

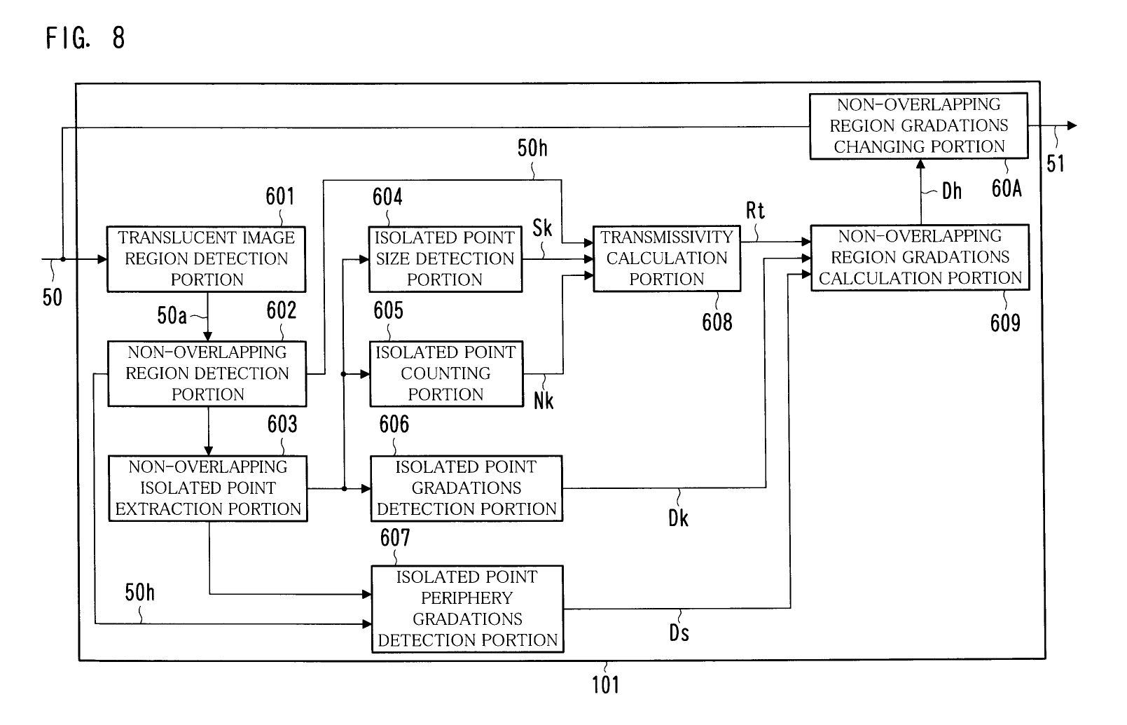

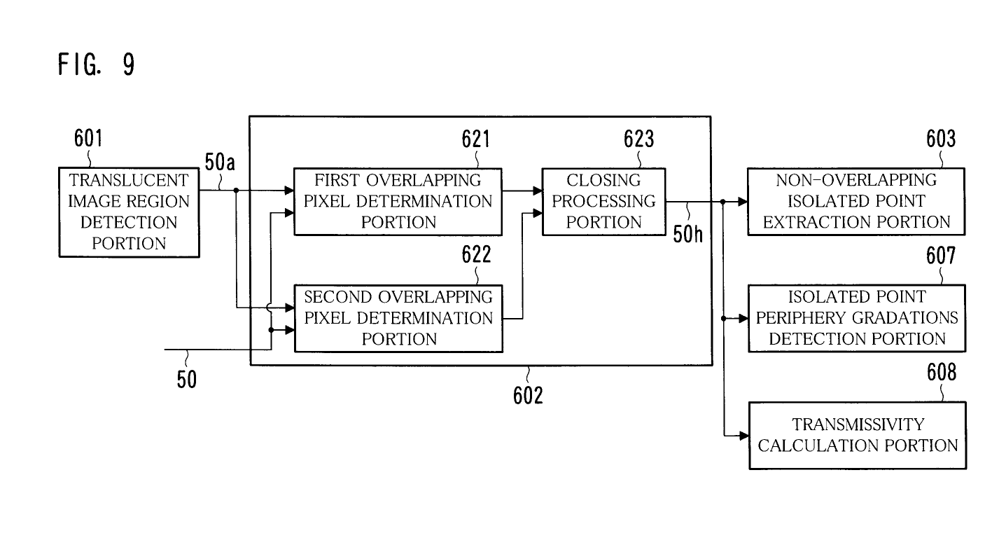

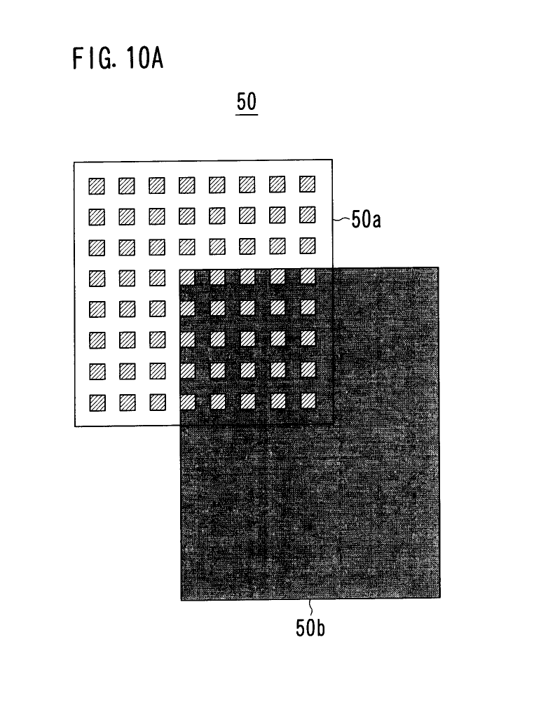

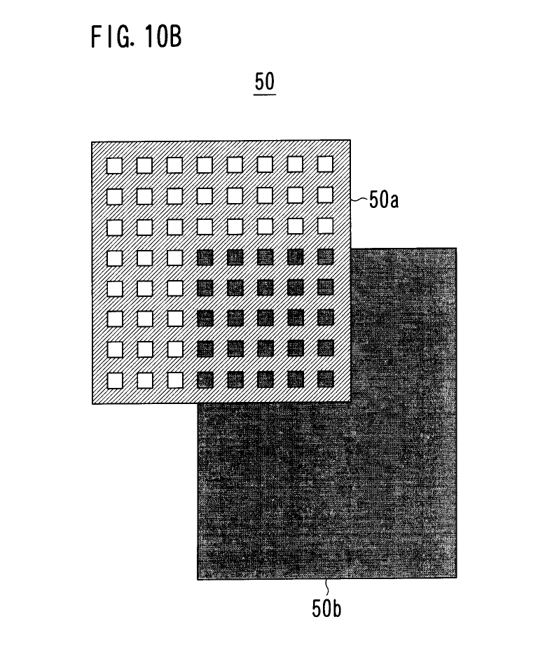

FIG. 3 is a diagram illustrating an example of the configuration of the image processing circuit 10j; FIGS. 4A and 4B are diagrams illustrating examples of the positional relationship between a translucent image 50a and a rear image 50b both of which are contained in a document image 50; FIGS. 5A to 5C are diagrams illustrating examples of the translucent image 50a; FIG. 6 is a diagram illustrating an example as to how the translucent image 50a and the rear image 50b overlap with each other in pixels; FIGS. 7A and 7B are diagrams illustrating examples of isolated points each of which consists of a plurality of pixels; FIG. 8 is a diagram illustrating an example of the configuration of a translucent image adjustment portion 101; FIG. 9 is a diagram illustrating an example of the configuration of a non-overlapping region detection portion 602; and FIGS. 10A and 10B are diagrams illustrating examples as to how the translucent image 50a and the rear image 50b overlap with each other in pixels for the case of high transmissivity and for the case of low transmissivity, respectively.

Referring to FIG. 3, the image processing circuit 10j is configured of the translucent image adjustment portion 101, an edge enhancement processing portion 102, and so on.

The image processing circuit 10j performs image processing on an image reproduced based on image data 70 transmitted from the personal computer 2. The image thus reproduced is hereinafter referred to as a “document image 50”.

The “edge enhancement processing” is processing to enhance the contour of an object such as a letter, diagram, or illustration contained in the document image 50, i.e., to enhance an edge of such an object.

The “translucent image” has properties which allow another object image placed in the rear thereof to be visible through the translucent image itself. In short, the translucent image represents a translucent object such as glass or Cellophane (registered trademark). Referring to FIG. 4A, for example, the translucent image 50a is placed in the foreground as compared to the rear image 50b having a rectangular shape. A part of the rear image 50b overlapping the translucent image 50a is seen through the translucent image 50a. The higher the transmissivity of the translucent image 50a is, the more the rear image 50b is visible therethrough. In the case where the transmissivity of the translucent image 50a is 0%, the part of the rear image 50b overlapping the translucent image 50a is completely hid, and therefore, the part is invisible as exemplified in FIG. 4B. The embodiment describes an example in which the rear image 50b is not a translucent image, i.e., is a non-translucent image.

In general, even if a translucent image is displayed, as shown in FIG. 5A, on the personal computer 2 in such a manner that all the pixels have constant density, the image is converted for printing, as shown in FIG. 5B or 5C, in such a manner to include pixels with constant density and pixels without constant density.

In FIGS. 5B and 5C, hatched pixels correspond to pixels with constant density Da, and non-hatched pixels correspond to pixels without the constant density Da. The same is similarly applied to FIGS. 6 through 7B. Hereinafter, a pixel with the constant density Da is referred to as a “density-present pixel”, and a pixel without the constant density Da is referred to as a “density-absent pixel”. Further, the “density” means gradations in color of, for example, Red, Green, and Blue for a case where the document image 50 is a color image. The “density” means a gray scale for a case where the document image 50 is a monochrome image.

An image corresponding to a density-present pixel is printed at predetermined density. As for a density-absent pixel, if no other image is placed in the rear of the translucent image, then nothing is printed at a part corresponding to the density-absent pixel. On the other hand, if another image is placed in the rear of the translucent image, then an image corresponding to a pixel of the other image whose position is the same as that of the density-absent pixel of the translucent image is printed. In this way, as shown in FIG. 6, an image corresponding to pixels of the rear image 50b whose positions are the same as those of the density-absent pixels of the translucent image 50a are printed. This allows a part of the rear image 50b overlapping the translucent image 50a to be printed in such a manner to be visible through the translucent image 50a. Such a part is hereinafter referred to as an “overlapping region”. The higher the transmissivity of the translucent image 50a is, the less a density-present pixel is likely to appear. Accordingly, the translucent image 50a shown in FIG. 5B has transmissivity higher than that of the translucent image 50a shown in FIG. 5C.

Each density-present pixel shown in FIG. 5B is surrounded by density-absent pixels. On the other hand, each density-absent pixel shown in FIG. 5C is surrounded by density-present pixels. Further, in some cases, a set of continuous density-present pixels, i.e., a pixel group, is surrounded by density-absent pixels as shown in FIG. 7A. In other cases, a pixel group of continuous density-absent pixels is surrounded by density-present pixels as shown in FIG. 7B.

Hereinafter, one pixel or pixel group surrounded by the other type pixel(s) is referred to as an “isolated point”. Accordingly, in the case of FIG. 5B, a density-present pixel is an isolated point pixel. In the case of FIG. 5C, a density-absent pixel is an isolated point pixel. In the case of FIG. 7A, a set of continuous density-present pixels is an isolated point. In the case of FIG. 7B, a set of continuous density-absent pixels is an isolated point.

Referring to FIG. 8, the translucent image adjustment portion 101, which is shown in FIG. 3, is configured of a translucent image region detection portion 601, a non-overlapping region detection portion 602, a non-overlapping isolated point extraction portion 603, an isolated point size detection portion 604, an isolated point counting portion 605, an isolated point gradations detection portion 606, an isolated point periphery gradations detection portion 607, a transmissivity calculation portion 608, a non-overlapping region gradations calculation portion 609, a non-overlapping region gradations changing portion 60A, and so on. The configuration of the translucent image adjustment portion 101 allows the same to perform a process for adjusting the translucent image 50a contained in the document image 50.

In FIG. 8, the translucent image region detection portion 601 detects a translucent image 50a in a document image 50. If image data 70 indicates the position and shape of the translucent image 50a, then the translucent image region detection portion 601 is capable of detecting the translucent image 50a based on the image data 70. If the image data 70 does not indicate the position and shape of the translucent image 50a, then the translucent image region detection portion 601 is capable of detecting the translucent image 50a in the following manner.

The translucent image region detection portion 601 detects an isolated point in the document image 50 as follows. A certain pixel is focused. The pixel is hereinafter referred to as a “pixel of interest”. Comparison is made between density (gradations) of the pixel of interest and density of each of other pixels (hereinafter, called “neighboring pixels”) adjacent to the pixel of interest. If a requirement that each difference between the density of the pixel of interest and density of each of the neighboring pixels is equal to or greater than a predetermined value D1 is met, then the translucent image region detection portion 601 detects the pixel of interest as an isolated point. Note that, where the document image 50 is a color image, such comparison is made separately for each color. If the requirement is met for any one of the colors, then the translucent image region detection portion 601 detects the pixel of interest as an isolated point. The same thing can be said to determination as to whether or not the requirement is met for the case where the document image 50 is a color image.

The translucent image region detection portion 601 directs attention to continuous pixels whose number is not less than two and is not more than a predetermined number (for example, nine) and which have each other's density difference not more than a predetermined value D2, i.e., which have substantially the same density level. Such continuous pixels are hereinafter referred to as a “group of pixels of interest”. Comparison is made between density (gradations) of the group of pixels of interest and density of each of neighboring pixels adjacent to the group of pixels of interest. If each difference between the density of the group of pixels of interest and density of each of the neighboring pixels is equal to or greater than a predetermined value D3, then the translucent image region detection portion 601 detects the group of pixels of interest as an isolated point.

Meanwhile, isolated points of a translucent image are seen with a periodicity (constant pattern) as shown in FIGS. 5B, 5C, 7A, and 7B. The translucent image region detection portion 601 extracts, from the detected isolated points, a plurality of isolated points for which a periodicity is observed.

The translucent image region detection portion 601, then, performs closing processing on an image showing the distribution of the plurality of isolated points thus extracted. Such an image showing the distribution is hereinafter referred to as a “distribution image”. To be specific, the translucent image region detection portion 601 performs processing for expanding (dilating) or scaling down (eroding) dots positioned at the individual isolated points. The position and shape of the distribution image that has undergone the closing processing correspond to the position and shape of the translucent image 50a.

The translucent image region detection portion 601 obtains the position and shape of the translucent image 50a in this manner, and detects the translucent image 50a in the document image 50.

The non-overlapping region detection portion 602 detects, in the translucent image 50a detected by the translucent image region detection portion 601, a non-overlapping region 50h that is a region not overlapping the rear image 50b.

If the image data 70 indicates the position and shape of the rear image 50b in addition to the position and shape of the translucent image 50a, then the non-overlapping region detection portion 602 is capable of detecting the non-overlapping region 50h based on the image data 70. If the image data 70 does not indicate the position and shape of the rear image 50b, then the non-overlapping region detection portion 602 detects a non-overlapping region 50h in the following manner.

Referring to FIG. 9, the non-overlapping region detection portion 602 is configured of a first overlapping pixel determination portion 621, a second overlapping pixel determination portion 622, a closing processing portion 623, and the like.

The first overlapping pixel determination portion 621 makes a determination as to whether or not each of the isolated points is positioned in an area where the translucent image 50a and the rear image 50b overlap with each other. Such an area is hereinafter referred to as an overlapping region. In particular, the first overlapping pixel determination portion 621 assumes the case where isolated points of the translucent image 50a consist of density-present pixels as shown in FIG. 10A and makes the determination in the following manner.

The first overlapping pixel determination portion 621 checks density of neighboring pixels of an isolated point. If the isolated point is adjacent to at least one of neighboring pixels having density equal to or greater than a predetermined value D4, then the first overlapping pixel determination portion 621 determines that the isolated point is positioned in the overlapping region. Otherwise, the first overlapping pixel determination portion 621 determines that the isolated point is not positioned in the overlapping region.

Likewise, the second overlapping pixel determination portion 622 makes a determination as to whether or not each of the isolated points is positioned in the overlapping region. The second overlapping pixel determination portion 622 assumes the case where isolated points of the translucent image 50a consist of density-absent pixels as shown in FIG. 10B and makes the determination in the following manner.

The second overlapping pixel determination portion 622 checks density of each of the isolated points. If an isolated point has density equal to or greater than a predetermined value D5, then the second overlapping pixel determination portion 622 determines that the isolated point is positioned in the overlapping region. As for isolated points for which this is not the case, the second overlapping pixel determination portion 622 determines that such isolated points are not positioned in the overlapping region.

The closing processing portion 623 performs closing processing on an image showing the distribution (distribution image) of isolated points that have not been determined to be positioned in the overlapping region by the first overlapping pixel determination portion 621 and by the second overlapping pixel determination portion 622. The position and shape of the distribution image that has undergone the closing processing correspond to the position and shape of the non-overlapping region 50h.

The non-overlapping isolated point extraction portion 603 extracts an isolated point positioned in the non-overlapping region 50h. Hereinafter, such an isolated point extracted by the non-overlapping isolated point extraction portion 603 is referred to as a “non-overlapping isolated point”.

The isolated point size detection portion 604 detects the size of a non-overlapping isolated point. In this embodiment, the size of a non-overlapping isolated point is represented by the number of pixels constituting the non-overlapping isolated point.

The isolated point counting portion 605 counts the number of non-overlapping isolated points. The isolated point gradations detection portion 606 detects gradations of a non-overlapping isolated point, i.e., density thereof.

The isolated point periphery gradations detection portion 607 detects gradations of pixels adjacent to a non-overlapping isolated point, i.e., gradations of pixels around the non-overlapping isolated point.

If an isolated point corresponds to a density-present pixel, then the transmissivity calculation portion 608 uses the following equation (1_{—}1) to calculate transmissivity Rt of the non-overlapping region 50h detected by the non-overlapping region detection portion 602. On the other hand, if an isolated point corresponds to a density-absent pixel, then the transmissivity calculation portion 608 uses the following equation (1_{—}2) to calculate transmissivity Rt of the non-overlapping region 50h detected by the non-overlapping region detection portion 602.

Rt=1−Sk×Nk/Sh (1_{—}1)

Rt=Sk×Nk/Sh (1_{—}2)

The symbols “Sk”, “Nk”, and “Sh” respectively represent a size detected by the isolated point size detection portion 604, a quantity counted by the isolated point counting portion 605, and a size of the non-overlapping region 50h.

If an isolated point corresponds to a density-present pixel, then the non-overlapping region gradations calculation portion 609 uses the following equation (2_{—}1) to calculate density (gradations) of each pixel constituting the non-overlapping region 50h. On the other hand, if an isolated point corresponds to a density-absent pixel, then the non-overlapping region gradations calculation portion 609 uses the following equation (2_{—}2) to calculate density (gradations) of each pixel constituting the non-overlapping region 50h.

Dh=Dk×(1−Rt) (2_{—}1)

Dh=Ds×Rt (2_{—}2)

The symbols “Dk” and “Ds” respectively represent density detected by the isolated point gradations detection portion 606, and density calculated by the isolated point periphery gradations detection portion 607.

Note that density Dh obtained by the calculation of each of the equations (2_{—}1) and (2_{—}2) is one for the case where a density-absent pixel has density of zero. If a density-absent pixel has density greater than zero and smaller than density Da, it is possible that the density Dh is obtained by the calculation of the equation (3_{—}1) instead of the equation (2_{—}1), and by the calculation of the equation (3_{—}2) instead of the equation (2_{—}2).

Dh=Dk×(1−Rt)+Ds×Rt (3_{—}1)

Dh=Ds×Rt+Dk×(1×Rt) (3_{—}2)

The non-overlapping region gradations changing portion 60A changes a density value of each of the pixels in the non-overlapping region 50h of the document image 50 to the density value Dh determined by the non-overlapping region gradations calculation portion 609. Hereinafter, the post-change document image 50 is called a “document image 51”.

Referring back to FIG. 3, the edge enhancement processing portion 102 performs edge enhancement processing on the end of each object image contained in the document image 51, except for the end (edge) of the non-overlapping region 50h. The document image 51 that has undergone the edge enhancement processing is hereinafter referred to as an “edge-enhanced image 52”. The printing unit 10f, then, prints the edge-enhanced image 52 onto paper.

In this embodiment, adjustment is so made that only the non-overlapping region 50h of the translucent image 50a has uniform gradations. Accordingly, it is possible to reduce graininess in the entire translucent image 50a as compared to conventional techniques with the rear image 50b kept visible through the translucent image 50a.

In this embodiment, the image processing circuit 10j performs image processing on a document image 50. Instead of this, however, the whole or a part of the functions of the image processing circuit 10j may be implemented by causing the CPU 10a to execute programs. In such a case, it is preferable to prepare programs in which steps of the processes shown in FIGS. 3, 8, and 9 are described and cause the CPU 10a to execute the programs.

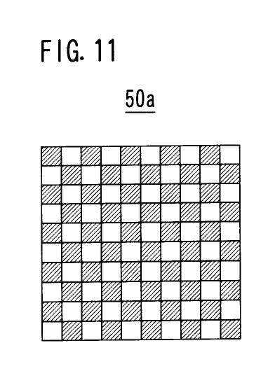

FIG. 11 is a diagram illustrating an example of a translucent image 50a having transmissivity of 50%. In the case where the translucent image 50a has transmissivity of approximately 0.5, both an isolated point consisting of a density-present pixel and an isolated point consisting of a density-absent pixel are sometimes seen. For example, all the pixels in the translucent image 50a shown in FIG. 11 are isolated points. In such a case, processing is performed in which only either one of the isolated point consisting of a density-present pixel and the isolated point consisting of a density-absent pixel is regarded as an isolated point, and the other is not regarded as an isolated point. For example, if the translucent image 50a has transmissivity equal to or greater than 0.5, then only an isolated point consisting of a density-present pixel is preferably regarded as an isolated point. On the other hand, if the translucent image 50a has transmissivity smaller than 0.5, then only an isolated point consisting of a density-absent pixel is preferably regarded as an isolated point.

In the embodiments discussed above, the overall configurations of the image forming apparatus 1, the configurations of various portions thereof, the content to be processed, the processing order, the configuration of the data, and the like may be altered as required in accordance with the subject matter of the present invention.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image processing apparatus for performing image processing on an image containing a first image and a second image, the second image representing a translucent object, the image processing apparatus comprising:
a detector that detects a non-overlapping region in the second image, the non-overlapping region being a region that does not overlap the first image; and
an equalizing portion that makes gradations in the non-overlapping region uniform.

2. The image processing apparatus according to claim 1, wherein, if the second image includes one or more pixel groups each of which has one or more continuous pixels and has density greater than density of neighboring pixels adjacent to each of said one or more pixel groups, then the detector detects the non-overlapping region by selecting, from among said one or more pixel groups, a pixel group that is not adjacent to the neighboring pixels having density equal to or greater than a predetermined value, and performing closing processing on a distribution image representing distribution of the pixel group thus selected.

3. The image processing apparatus according to claim 2, wherein the equalizing portion makes the gradations in the non-overlapping region uniform based on a size of the non-overlapping region, density, a size, and a quantity of the pixel group selected.

4. The image processing apparatus according to claim 1, wherein, if the second image includes one or more pixel groups each of which has one or more continuous pixels and has density less than density of neighboring pixels adjacent to each of said one or more pixel groups, then the detector detects the non-overlapping region by selecting, from among said one or more pixel groups, a pixel group having density less than a predetermined value, and performing closing processing on a distribution image representing distribution of the pixel group thus selected.

5. The image processing apparatus according to claim 4, wherein the equalizing portion makes the gradations in the non-overlapping region uniform based on a size of the non-overlapping region, density of the neighboring pixels, a size and a quantity of the pixel group selected.

6. An image processing method for performing image processing on an image containing a first image and a second image, the second image representing a translucent object, the image processing method comprising:
detecting a non-overlapping region in the second image, the non-overlapping region being a region that does not overlap the first image; and
making gradations in the non-overlapping region uniform.

7. The image processing method according to claim 6, wherein, if the second image includes one or more pixel groups each of which has one or more continuous pixels and has density greater than density of neighboring pixels adjacent to each of said one or more pixel groups, then the non-overlapping region is detected by selecting, from among said one or more pixel groups, a pixel group that is not adjacent to the neighboring pixels having density equal to or greater than a predetermined value, and performing closing processing on a distribution image representing distribution of the pixel group thus selected.

8. The image processing method according to claim 7, wherein the gradations in the non-overlapping region is made uniform based on a size of the non-overlapping region, density, a size, and a quantity of the pixel group selected.

9. The image processing method according to claim 6, wherein, if the second image includes one or more pixel groups each of which has one or more continuous pixels and has density less than density of neighboring pixels adjacent to each of said one or more pixel groups, then the non-overlapping region is detected by selecting, from among said one or more pixel groups, a pixel group having density less than a predetermined value, and performing closing processing on a distribution image representing distribution of the pixel group thus selected.

10. The image processing method according to claim 9, wherein the gradations in the non-overlapping region is made uniform based on a size of the non-overlapping region, density of the neighboring pixels, a size and a quantity of the pixel group selected.

11. A non-transitory computer-readable storage medium storing thereon a computer program used in a computer for performing image processing on an image containing a first image and a second image, the second image representing a translucent object, the computer program causing the computer to perform:
a first process for detecting a non-overlapping region in the second image, the non-overlapping region being a region that does not overlap the first image; and
a second process for making gradations in the non-overlapping region uniform.

12. The non-transitory computer-readable storage medium according to claim 11, wherein, if the second image includes one or more pixel groups each of which has one or more continuous pixels and has density greater than density of neighboring pixels adjacent to each of said one or more pixel groups, then the computer program causes the computer to perform, as the first process, a process for selecting, from among said one or more pixel groups, a pixel group that is not adjacent to the neighboring pixels having density equal to or greater than a predetermined value, and closing processing on a distribution image representing distribution of the pixel group thus selected.

13. The non-transitory computer-readable storage medium according to claim 12, wherein the computer program causes the computer to perform the second process based on a size of the non-overlapping region, density, a size, and a quantity of the pixel group selected.

14. The non-transitory computer-readable storage medium according to claim 11, wherein, if the second image includes one or more pixel groups each of which has one or more continuous pixels and has density less than density of neighboring pixels adjacent to each of said one or more pixel groups, then the computer program causes the computer to perform, as the first process, a process for selecting, from among said one or more pixel groups, a pixel group having density less than a predetermined value, and closing processing on a distribution image representing distribution of the pixel group thus selected.

15. The non-transitory computer-readable storage medium according to claim 14, wherein the computer program causes the computer to perform the second process based on a size of the non-overlapping region, density of the neighboring pixels, a size and a quantity of the pixel group selected.
